(19) United States
(12) Patent Application Publication
(10) Pub. No.: US 2014/0007508 A1
(43) Pub. Date: Jan. 9, 2014

(54) PAIR OF OVEN DOORS

(71) Applicant: John Bourque, Ville Platte, LA (US)

(72) Inventor: John Bourque, Ville Platte, LA (US)

(21) Appl. No.: 13/543,589

(22) Filed: Jul. 6, 2012

(51) Int. Cl. E06B 5/00

(52) U.S. Cl. 49/366

(57) ABSTRACT

The present invention is a pair of oven doors attached to an oven that include a first oven door with a first top facing, the first oven door is attached to a first side of an oven's opening and a second oven door with a second top facing, the second oven door is attached to a second side of the oven's opening. The pair of side hinges each swingably attaches the first oven door to the first side and the second oven door to the second side and a pair of handles are each disposed on the first top facing and the second top facing.

### TECHNICAL FIELD & BACKGROUND

Conventional ovens are designed to open by pulling a door down in front of a stove. This traditional design for oven doors may be dangerous, increasing the risk of an individual being burned.

The present invention generally relates to an oven door design. More specifically, the invention is a pair of oven doors.

It is an object of the invention to provide a pair of oven doors that allows a user to open the pair of doors from left to right to facilitate placing items in an oven.

It is an object of the invention to provide a pair of oven doors that is relatively safer than a relatively larger traditional single door oven door.

It is an object of the invention to provide a pair of oven doors that is relatively more stylish and aesthetically pleasing than a single traditional oven door.

What is really needed is a pair of oven doors that allows a user to open the pair of doors from left to right to facilitate placing items in an oven that is relatively safer than a relatively larger traditional single door oven door that is relatively more stylish and aesthetically pleasing than a single traditional oven door.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a pair of oven doors in a closed position, according to an embodiment of the present invention.

FIG. 1B illustrates a front view of a pair of oven doors in an open position, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

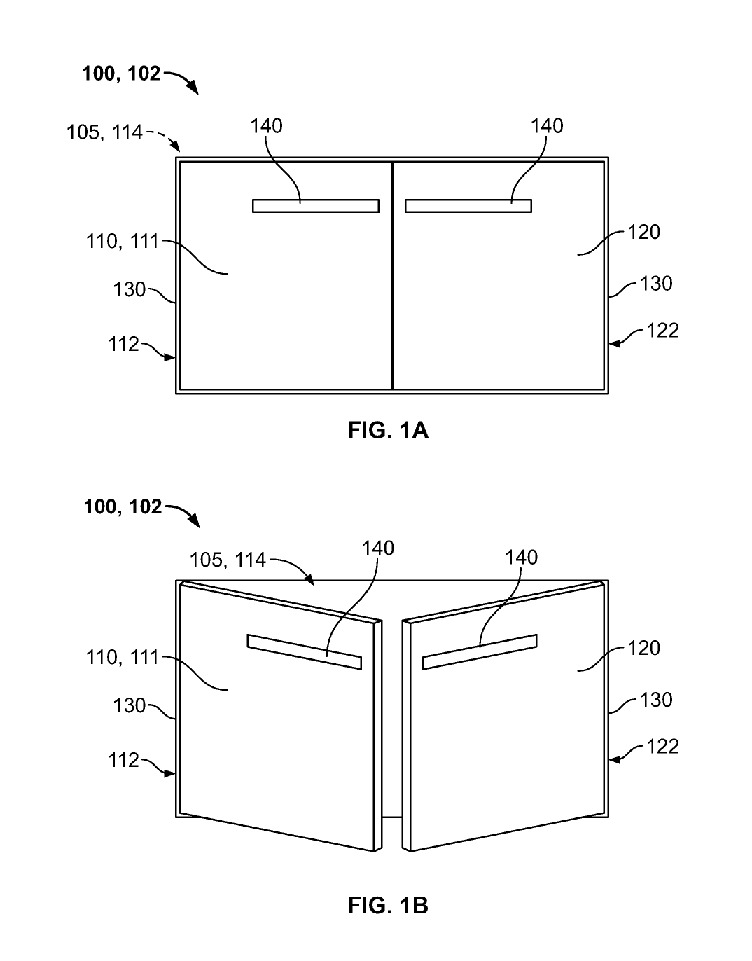

FIG. 1A illustrates a front view of a pair of oven doors 100 in a closed position, according to an embodiment of the present invention. The pair of oven doors 100 can be attached to any suitable oven 105.

The pair of oven doors 100 includes a first oven door 110, a second oven door 120, a pair of side hinges 130 and a pair of handles 140. The pair of oven doors 100 is a French style pair of oven doors 102. The first oven door 110 includes a first top facing 111 and is attached to a first side 112 of an oven's opening 114. The first oven door 110 can be made of heat-resistant insulated glass, heat-resistant insulated metal and glass or any other suitable material. The second oven door 120 includes a second top facing 121 and is attached to a second side 122 of the oven's opening 114. The second oven door 120 can be made of heat-resistant insulated glass, heat-resistant insulated metal and glass or any other suitable material. The first oven door 110 and the second oven door 120 are sealed when they come together in a closed position to prevent heat loss from the oven's opening 114 when the oven 105 is utilized, as is illustrated in FIG. 1A. The pair of side hinges 130 each swingably attach the first oven door 110 to the first side 112 and the second oven door 120 to the second side 122. The pair of handles 140 each are disposed on the first top facing 111 and the second top facing 121 although the pair of handles 140 can be disposed on any suitable location on the first top facing 111 and the second top facing 121 of the pair of oven doors 100. The pair of handles 140 is also heat resistant.

FIG. 1B illustrates a front view of a pair of oven doors 100 in an open position, according to an embodiment of the present invention.

The pair of oven doors 100 illustrated and described in FIG. 1B are similar to the pair of oven doors 100 illustrated and described in FIG. 1A and include the first oven door 110, the second oven door 120, the pair of side hinges 130 and the pair of handles 140. In contrast to FIG. 1A, FIG. 1B illustrates the pair of oven doors 100 in an open position. The pair of oven doors 100 can be opened from the first side 112 with a first oven door 110 or from a second side 122 with a second oven door 120. This ability to open a door from a first or left side or the second or right side is relatively safer than opening a single oven door from the top down to the bottom.

The pair of oven doors has a pair of French style doors incorporated into a design, the pair of oven doors are a well suited alternative to other single oven doors. The pair of oven doors allows individuals to open their ovens from left to right, facilitating the process of placing items within the oven, without the risk of coming too close to an adjacent stove. Among those who will find the pair of oven doors relatively convenient and safe are appliance manufacturers, people in the restaurant industry and the everyday consumer. The pair of oven doors features an oven engineered with a pair of French-style doors. The pair of oven doors is designed to be relatively durable, easy to open and create a proper seal when closing.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pair of oven doors attached to an oven, comprising:
a first oven door with a first top facing, said first oven door is attached to a first side of an oven's opening;
a second oven door with a second top facing, said second oven door is attached to a second side of said oven's opening;
a pair of side hinges each swingably attach said first oven door to said first side and said second oven door to said second side; and
a pair of handles each disposed on said first top facing and said second top facing.

2. The pair of oven doors according to claim 1, wherein said first oven door is made of heat-resistant insulated glass.

3. The pair of oven doors according to claim 1, wherein said first oven door and said second oven door are sealed when said first oven door and said second oven door come together in a closed position to prevent heat loss from said oven's opening when said oven is utilized.

4. The pair of oven doors according to claim 1, wherein said second oven door is made of heat-resistant insulated glass.

5. The pair of oven doors according to claim 1, wherein said pair of oven doors is a French style pair of oven doors.

6. The pair of oven doors according to claim 1, wherein said first oven door is opened from said first side.

7. The pair of oven doors according to claim 1, wherein said second oven door is opened from said second side.

8. A pair of oven doors attached to an oven, comprising:
a first oven door with a first top facing, said first oven door is attached to a first side of an oven's opening;
a second oven door with a second top facing, said second oven door is attached to a second side of said oven's opening, wherein said first oven door and said second oven door are sealed when said first oven door and said second oven door come together in a closed position to prevent heat loss from said oven's opening when said oven is utilized;
a pair of side hinges each swingably attach said first oven door to said first side and said second oven door to said second side; and
a pair of handles each disposed on said first top facing and said second top facing.

9. The pair of oven doors according to claim 8, wherein said first oven door is made of heat-resistant insulated glass.

10. The pair of oven doors according to claim 8, wherein said second oven door is made of heat-resistant insulated glass.

11. The pair of oven doors according to claim 8, wherein said pair of oven doors is a French style pair of oven doors.

12. The pair of oven doors according to claim 8, wherein said first oven door is opened from said first side.

13. The pair of oven doors according to claim 8, wherein said second oven door is opened from said second side.

14. The pair of oven doors according to claim 8, wherein said pair of handles is heat resistant.

15. A pair of oven doors attached to an oven, comprising:
a heat-resistant insulated glass first oven door with a first top facing, said first oven door is attached to a first side of an oven's opening;
a heat-resistant insulated glass second oven door with a second top facing, said second oven door is attached to a second side of said oven's opening, wherein said first oven door and said second oven door are sealed when said first oven door and said second oven door come together in a closed position to prevent heat loss from said oven's opening when said oven is utilized;
a pair of side hinges each swingably attach said first oven door to said first side and said second oven door to said second side; and
a pair of heat resistant handles each disposed on said first top facing and said second top facing.

16. The pair of oven doors according to claim 15, wherein said first oven door is made of heat-resistant insulated metal and glass.

17. The pair of oven doors according to claim 15, wherein said second oven door is made of heat-resistant insulated metal and glass.

18. The pair of oven doors according to claim 15, wherein said pair of oven doors is a pair of French style oven doors.

19. The pair of oven doors according to claim 15, wherein said first oven door is opened from said first side.

20. The pair of oven doors according to claim 15, wherein said second oven door is opened from said second side.
